(19) United States
(12) Patent Application Publication
(10) Pub. No.: US 2024/0009739 A1
(43) Pub. Date: Jan. 11, 2024

(54) DEHUMIDIFY AND RECYCLE A GAS FROM A 3D PRINTER

(71) Applicant: HEWLETT-PACKARD DEVELOPMENT COMPANY, L.P., Spring, TX (US)

(72) Inventors: Rhys Mansell, Sant Cugat del Valles (ES); Mohammad Jowkar, Sant Cugat del Valles (ES); Carlos Eduardo Caballero Diaz, Sant Cugat del Valles (ES)

(73) Assignee: HEWLETT-PACKARD DEVELOPMENT COMPANY, L.P., Spring, TX (US)

(21) Appl. No.: 17/786,038

(22) PCT Filed: Apr. 27, 2020
(86) PCT No.: PCT/US2020/030030

§ 371 Date: Jun. 16, 2022

(51) Int. Cl. B22F 10/77; B29C 64/357; B29C 64/393; B22F 10/322; B33Y 30/00; B33Y 50/02; B33Y 40/00

(52) U.S. Cl. CPC B22F 10/77; B29C 64/357; B29C 64/393; B22F 10/322; B33Y 30/00; B33Y 50/02; B33Y 40/00

(57) ABSTRACT

A 3D printing apparatus to dehumidify and recycle a gas from a 3D printer is disclosed herein. The apparatus comprises: a gas inlet to receive a gas flow from a 3D printer, the gas flow comprising gas with evaporated solvents to be cleaned; a heat exchanger to dehumidify the gas flow from the evaporated solvents, the heat exchanger to cool the gas flow by heat transfer to a cold liquid stream from a chiller to saturate and condensate the solvents from the gas flow; a gas outlet to output the dehumidified gas flow back to the 3D printer; and a controller. The controller is to receive a humidity and temperature measurements from a sensor located downstream from the heat exchanger; compare the humidity and temperature measurements with a target humidity and a target temperature respectively; and control a chiller valve from the chiller based on the comparison to adjust the temperature of the gas flow to set an absolute humidity of the gas flow to a predeterminable value.

### BACKGROUND

Some additive manufacturing or three-dimensional printing systems generate 3D objects by selectively solidifying portions of a successively formed layers of build material on a layer-by-layer basis.

### BRIEF DESCRIPTION OF THE DRAWINGS

The present application may be more fully appreciated in connection with the following detailed description of non-limiting examples taken in conjunction with the accompanying drawings, in which like reference characters refer to like parts throughout and in which:

FIG. 1 is a schematic diagram showing an example of a 3D printing apparatus to dehumidify and recycle a gas from a 3D printer;

FIG. 2 is a flowchart of an example method of dehumidifying and recycling a gas from a 3D printer;

FIG. 3 is a schematic graph of an example of a psychrometric chart;

FIG. 4 is a schematic diagram showing another example of a 3D printing apparatus to dehumidify and recycle a gas from a 3D printer;

FIG. 5 is a schematic diagram showing another example of a 3D printing apparatus to dehumidify and recycle a gas from a 3D printer;

FIG. 6 is a schematic diagram showing another example of a 3D printing apparatus to dehumidify and recycle a gas from a 3D printer; and

FIG. 7 is a schematic diagram showing an example of a 3D printer that dehumidifies and recycles a gas.

### DETAILED DESCRIPTION

The following description is directed to various examples of additive manufacturing, or three-dimensional printing, apparatus and processes involved in the generation of 3D objects. Throughout the present disclosure, the terms “a” and “an” are intended to denote at least one of a particular element. In addition, as used herein, the term “includes” means includes but not limited to, the term “including” means including but not limited to. The term “based on” means based at least in part on.

For simplicity, it is to be understood that in the present disclosure, elements with the same reference numerals in different figures may be structurally the same and may perform the same functionality.

3D printers generate 3D objects based on data in a 3D model of an object to be generated, for example, using a CAD computer program product. 3D printers may generate 3D objects by selectively processing layers of build material. For example, a 3D printer may selectively solidify portions of a layer of build material, e.g. a powder, corresponding to a slice of 3D object to be generated, thereby leaving the portions of the layer un-solidified in the areas where no 3D object is to be generated. The combination of the generated 3D objects and the un-solidified build material may also be referred to as build bed.

The volume in which the build bed is generated may be referred to as a build chamber.

Suitable powder-based build materials for use in additive manufacturing include polymer powder, metal powder or ceramic powder. In some examples, non-powdered build materials may be used such as gels, pastes, and slurries. Some types of build materials may be used under normal atmospheric conditions, whereas some build materials may be used in an inert atmosphere (e.g., due to oxidation risk, or explosion risk). Some inert gases suitable for the generation of a 3D object may include, for example, nitrogen or carbon dioxide.

Some 3D printers selectively solidify portions of a build material layer corresponding to the geometry of the object to be generated through the ejection of a printing fluid onto the build material layer, the printing fluid may be a curable binder liquid, an energy absorbing fusing liquid, a detailing agent or any printing fluid suitable for the generation of a 3D object. Additionally, the chemical composition of some printing fluids may include, for example, a liquid vehicle and/or solvent to be evaporated once the printing fluid have been applied to the build material layer. For simplicity, the liquid vehicle and/or solvents may be referred hereinafter as solvents. The evaporated solvents may mix with the gas in the build chamber (e.g., ambient air, inert gas). The mix of the gas with the evaporated solvents is further removed from the build chamber.

To avoid part quality defects during the generation of the 3D objects, the build chamber may contain a gas with specific temperature and humidity values. For example, the gas may be present in the build chamber, and may be present between particles of build material in the build chamber. The gas may be supplied to the build chamber in an airflow manner. The composition of the build chamber airflows may also influence the part quality of the 3D objects to be generated. For example, an excessive amount of evaporated solvents in a sealed build chamber may have an impact on the build material in which the 3D objects are to be generated. Thus, it is useful to remove the evaporated solvents from the build chamber using an exhaust gas airflow. Furthermore, some types of build material may require to be in contact with an oxygen free gas, for example an inert gas, to remove any risk of explosion or oxidization. In these examples, a mix of the inert gas and the evaporated solvents are exhausted from the build chamber. In some examples, the inert gas may be recycled. However, a removed gas with evaporated solvents mixed therein may not be suitable for recycling as such solvents may modify the temperature, humidity and composition of the gas and have an associated effect in the part quality of the 3D objects.

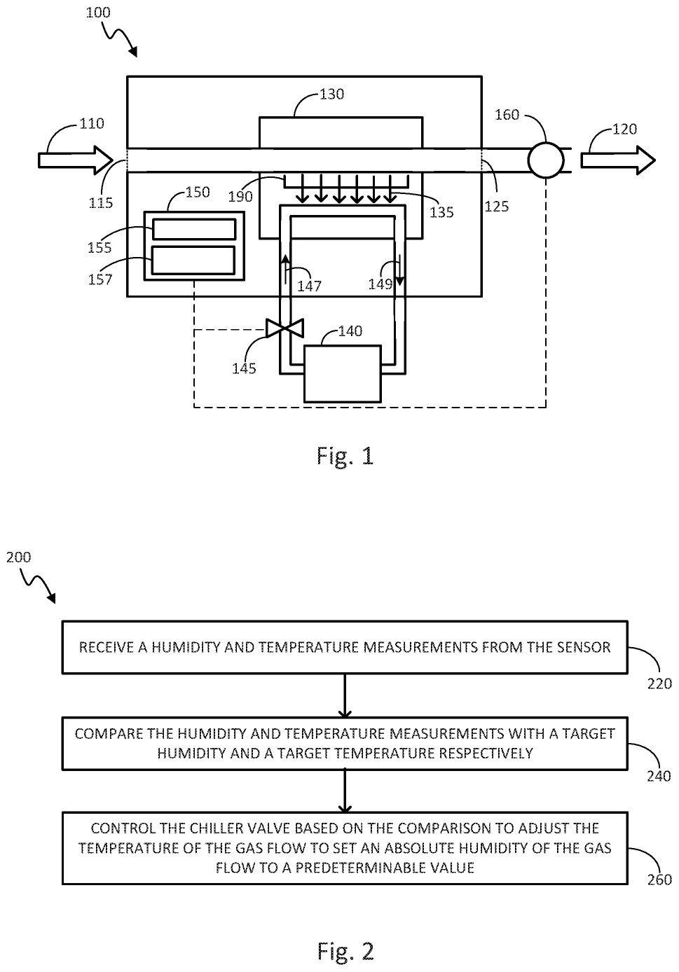

Referring now to the drawings, FIG. 1 is a schematic diagram showing an example of a 3D printing apparatus 100 to dehumidify and recycle a gas from a 3D printer. Additionally, the 3D printing apparatus 100 is to control the humidity and temperature of the recycled gas in a 3D printer build chamber. In some examples, the apparatus 100 may be an integral part of the 3D printer. In other examples, however, the apparatus 100 is an independent entity fluidically couplable with the 3D printer by means of conduits. In the present disclosure, a conduit may be understood as any channel for conveying a fluid (e.g., ambient air, inert gas). An example of a conduit is a rigid or semi-rigid tube that may have a circular section, or any other section.

The apparatus 100 comprises a gas inlet 115 couplable to a first conduit (not shown) that fluidically connects the build chamber of the 3D printer with the gas inlet 115. The gas inlet 115 is to receive a relatively hot gas flow 110 from the 3D printer. The gas flow 110 from the 3D printer comprises a gas mixed with evaporated solvents to be cleaned. In the present disclosure, the terms “to clean” and “to dehumidify” may be understood as to separate the evaporated solvents from the gas. The evaporated solvents may be generated from water, alcohol, or other liquid evaporated in the build chamber during the generation of the 3D object.

The apparatus 100 further comprises a heat exchanger 130 to separate (e.g., dehumidify) the gas flow 110 from the evaporated solvents. The heat exchanger 130 may be implemented as a liquid-to-gas heat exchanger, thereby enabling heat exchange between the relatively hot gas flow 110 with a relatively cold liquid stream 147 from a chiller 140. The chiller 140 may be any machine suitable for removing heat from a liquid via a vapor-compression or absorption refrigeration cycle, for example. In some examples, the chiller 140 is an external element from the apparatus 100 that interacts with the heat exchanger 130. In other examples, the chiller 140 is an integral part of the apparatus 100.

The heat exchanger 130 is, therefore, to cool the gas flow 110 by heat transfer 135 to a cold liquid stream 147 from the chiller 140 to saturate and condensate, and thereby separate, the solvents from the gas flow. After the heat transfer 135, the liquid stream 149 warms up due to the absorption of heat from the gas flow 110 and is recirculated back to the chiller 140 to cool it down as the cold liquid stream 147. The condensed solvents may be collected in a collection tank or a collection tray 190 for further removal.

The chiller 140 additionally comprises a chiller valve 145 to control the flow rate of cold liquid stream 147 inputted to the heat exchanger 130. Therefore, the chiller valve 145 controls the magnitude of the heat transfer 135 and may be used to regulate the amount of condensed liquid including the solvents. The chiller valve 145 is controlled by a controller 150. Additionally, or alternatively, the chiller 140 may control the temperature of the cold liquid stream 145 to further regulate the amount of condensed liquid including the solvents.

The apparatus 100 further comprises a gas outlet 125 couplable to a second conduit that fluidically connects the gas output port of the heat exchanger 130 with the gas outlet 125. The gas outlet 125 is therefore to receive the dehumidified gas flow 120 from the heat exchanger 130. The dehumidified gas flow 120 may be totally dehumidified, partially dehumidified of dehumidified below a predeterminable level. In some examples, the gas outlet 125 is to output the dehumidified gas flow 120 back to the 3D printer through, for example, an external output conduit to recycle the gas.

Additionally, a sensor 160 may be installed downstream from the heat exchanger 130 to measure the temperature and the humidity of the dehumidified gas flow 120. In some examples, the sensor 160 may be a device integrating a thermometer and a hygrometer. In other examples, the sensor 160 may comprise a first sensor to measure the temperature and a second independent sensor to measure the humidity of the gas flow 120. In an example, the sensor 160 may be part of the apparatus 100 and may be installed in the second conduit; i.e., between the heat exchanger 130 and the gas outlet 125. In another example, however, the sensor may be an external element from the apparatus 100 and may be installed in the external output conduit; i.e., between the gas outlet 125 and the 3D printer. The sensor 160 is coupled to the controller 150.

The controller 150 comprises a processor 155 and a memory 157 with specific control instructions to be executed by the processor 155. The controller 150 is coupled to the chiller valve 145 and the sensor 160. The controller 150 may control some of the operations of the elements that it is coupled with. The functionality of the controller 150 is described further below with reference to FIG. 2.

In the examples herein, the controller 150 may be any combination of hardware and programming that may be implemented in a number of different ways. For example, the programming of modules may be processor-executable instructions stored in at least one non-transitory machine-readable storage medium and the hardware for modules may include at least one processor to execute those instructions. In some examples described herein, multiple modules may be collectively implemented by a combination of hardware and programming. In other examples, the functionalities of the controller 150 may be, at least partially, implemented in the form of an electronic circuitry. The controller 150 may be a distributed controller, a plurality of controllers, and the like.

FIG. 2 is a flowchart of an example method 200 of dehumidifying and recycling a gas from a 3D printer, for example using apparatus 100 of FIG. 1. The method 200 may involve previously disclosed elements from FIG. 1 referred to with the same reference numerals. In some examples, method 100 may be executed by the controller 150.

The method 200 starts when a gas flow 110 with evaporated solvents from a 3D printer is received through the gas inlet 115 and transferred to the heat exchanger 130, where the solvents are condensed and thereby separated from the dehumidified gas flow 120. The dehumidified gas flow 120 may be then recycled and transferred back to the 3D printer.

At block 220, the controller 150 controls the sensor 160 to receive from the sensor 160 the temperature and the humidity of the dehumidified gas flow 120. The controller 150 may then receive the temperature and humidity measurements. The received temperature and humidity measurements may be indicative of the conditions in which the build chamber is generating the 3D objects. The sensor 160 may measure the humidity of the gas flow which may include the absolute humidity and/or the relative humidity.

In the examples herein, the absolute humidity may be understood as the quantity of evaporated solvent (e.g., water) dispersed in a kilogram of the gas (e.g., ambient air, inert gas). The relative humidity may be understood as the amount of evaporated solvent present in the gas expressed as a percentage of the amount needed for saturation at the same temperature.

At block 240, the controller 150 compares the humidity and temperature measurements with a target humidity and a target temperature respectively. In some examples herein, the target humidity and the target temperature may be a range of target humidity and a range of target temperatures.

If the measured humidity and/or temperature are above the target humidity and/or target temperature respectively, it may be indicative that the gas flow 110 from the 3D printer has not condensed enough solvents, being thereby indicative that the recycled gas flow 120 may not be completely dehumidified and may potentially affect the part quality of the 3D objects to be generated. Contrarily, if the measured humidity and/or temperature are below the target humidity and/or target temperature respectively, it may be indicative that the gas flow 120 from the 3D printer may have condensed excessively.

At block 260, the controller 150 controls the chiller valve 145 to set an absolute humidity of the gas flow to a predetermined value. In an example, the controller 150 may control the valve 145 to open and close. In another example, the controller 150 may control the chiller valve 145 to fully open, fully close, partially open, or partially close, where the partial positions may comprise any position ranging from the fully opened and fully closed positions.

If the measured humidity and/or temperature are above the target humidity and/or target temperature respectively, the controller 150 may control the chiller valve 145 to open or partially open so that a larger cold liquid stream 147 flow reaches the heat exchanger 130, thereby increasing the heat transfer 135 from the gas flow 110 from the 3D printer to the cold liquid stream 147, and therefore condensing a larger amount of solvents. Contrarily, if the measured humidity and/or temperature are below the target humidity and/or target temperature respectively, the controller 150 may control the chiller valve 145 to close or partially close so that a smaller cold liquid stream 147 flow reaches the heat exchanger 130, thereby reducing the heat transfer 135 from the gas flow 110 from the 3D printer to the cold liquid stream 147, and therefore condensing a smaller amount of solvents.

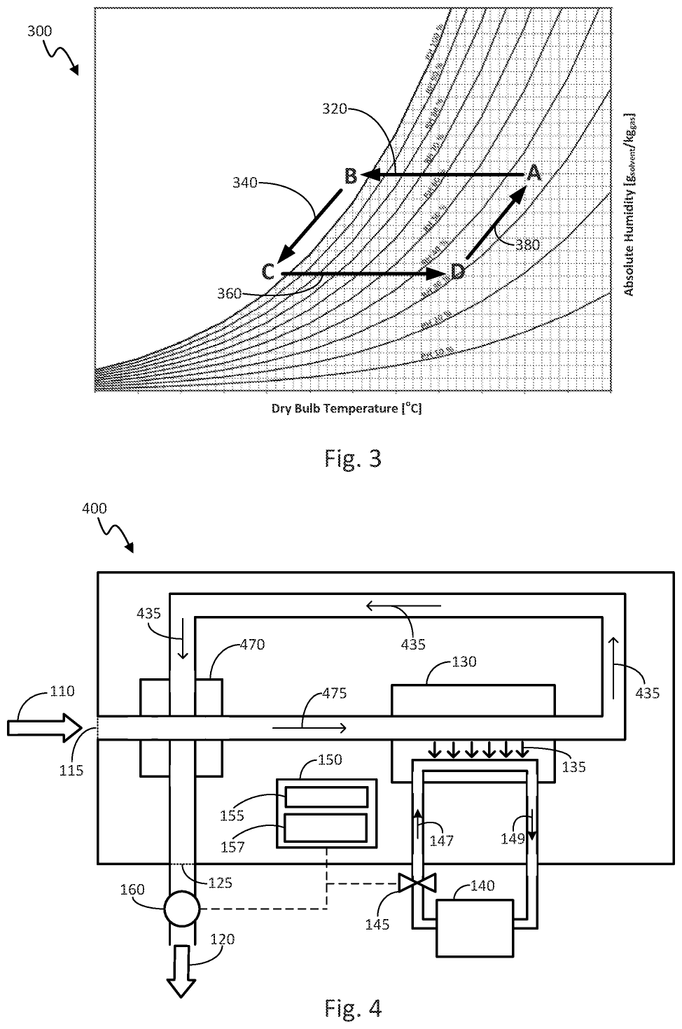

FIG. 3 is a schematic graph 300 of an example of a psychrometric chart to illustrate the thermodynamic cycle of the examples of the present disclosure.

Graph 300 illustrates the behavior of different relative humidity values of a gas, for example ambient air, an inert gas, water vapor, or any vaporized solvent. Graph 300 shows the different relative humidity, temperature and absolute humidity values for a given pressure.

As mentioned above, absolute humidity is the quantity of evaporated solvent (e.g., water) dispersed in a kilogram of the gas (e.g., ambient air, inert gas). Relative humidity is the amount of evaporated solvent present in the gas expressed as a percentage of the amount needed for saturation at the same temperature. Therefore, a 100% relative humidity is indicative that the gas is saturated with vapour so that if it is further cooled down, part of the vapour may start to condense. The more the saturated gas is cooled down, the more the evaporated solvents mixed therein may condense. The condensation may involve transforming part of the gas (e.g., the evaporated solvents) into liquid form, thereby enabling the separation between the condensed liquid solvents from the dehumidified gas.

Some thermodynamic states are illustrated in graph 300 which correspond to the thermodynamic cycle of the gas in the apparatus 100 from FIG. 1. State A may correspond to the gas in the gas flow 110 with evaporated solvents from the 3D printer. In some examples, the gas at state A comprises a high absolute humidity, high temperature, and a relative humidity below saturation. The gas flow 110 enters to the heat exchanger 130 where the gas is cooled. In the heat exchanger 130 the gas experiences the transition from state A to state B (illustrated through arrow 320) where the gas saturates. The gas at state B has substantially the same absolute humidity as the gas at state A but with a lower temperature and a relative humidity corresponding to saturation. The heat exchanger 130 may further cool down the saturated gas so that the vaporized solvents condense, thereby transitioning the gas from state B to state C (illustrated through arrow 340). At state C, the gas has a lower absolute humidity and temperature than the gas at state B, but the gas is still at a saturation point. During the condensation phase, solvent vapours are removed from the saturated gas and, therefore, the saturated gas experiences a reduction of the absolute humidity. The saturated gas is saturated (i.e., is at 100% relative humidity) throughout the solvent vapour condensation process. The resulting dehumidified gas 120 is then transferred to the 3D printer.

In the 3D printer, the dehumidified gas 120 may be heated by a heating element (e.g., gas heater) before entering back again to the print chamber. This heating process may increase the temperature of the dehumidified gas, which may transition from state C to state D (illustrated through arrow 360). In some examples, the gas at state D has substantially the same absolute humidity as the gas at state C, but the gas has a higher temperature and a lower relative humidity (i.e., the gas is no longer saturated). This heated gas at state D may then enter to the print chamber and be used during the generation of a 3D object.

The controller 150 may control the elements of apparatus 100 so that the gas at state D has an intended temperature and humidity value, for example that may be optimal for the generation of 3D objects in the build chamber of the 3D printer. In an example, the gas at state D has a temperature from 20° C. to 45° C., for example 30° C. or 35° C.; and a relative humidity from 20% to 70%, for example 40% or 50%. In another example, the gas at state D has a temperature from 10° C. to 60° C., for example 25° C. or 50° C.; and a relative humidity from 10% to 80%, for example 30% or 60%. In yet another example, the gas at state D has a temperature from 30° C. to 40° C.; and a relative humidity from 25% to 30%.

This thermodynamic cycle completes during the generation of the 3D object where some solvents are evaporated into the gas (i.e., gas flow 110 from the 3D printer). The gas with the evaporated solvents is transferred to the apparatus 100. The energy sources from the build chamber may heat the gas and the solvents evaporate into the gas, thereby increasing the temperature and absolute humidity of the gas. This may cause the transition from state D to state A (illustrated through arrow 380).

This aforementioned thermodynamic cycle (i.e., states A, B, C and D) may repeat throughout the generation of a print job by the 3D printer.

FIG. 4 is another schematic diagram showing another example of a 3D printing apparatus 400 to dehumidify and recycle a gas from a 3D printer (not shown). Additionally, the 3D printing apparatus 100 is to control the humidity and temperature of the recycled gas in the build chamber. The apparatus 400 may comprise previously disclosed elements from FIG. 1 referred to with the same reference numerals. The apparatus 400 comprises the gas inlet 115, the heat exchanger 130, the gas outlet 125 and the controller 150. The apparatus 400 may additionally comprise or may be engageable with the chiller 140 and the sensor 160. The controller 150 is coupled to the sensor 160 and the chiller valve 145 from the chiller 140.

The apparatus 400 additionally comprises a recuperator 470. The recuperator 470 is a gas-to-gas heat exchanger. The dehumidified gas flow 435, resulting from the liquid-to-gas heat exchanger 130, is intended to be used to heat the gas flow 110 from the 3D printer. The heated gas flow with evaporated solvents is illustrated with reference to arrow 475. Similarly, the gas flow 110 from the 3D printer is intended to be used to cool the dehumidified gas flow 435 resulting from the liquid-to-gas heat exchanger 130, thereby outputting dehumidified gas flow 120 which may be transferred to the 3D printer.

The recuperator 470 enables the gas flow with evaporated solvents 475 to enter to the heat exchanger 130 at a higher temperature. In the graph 300 of FIG. 3, the recuperator 470 may heat the gas flow with evaporated solvents 475 at a thermodynamic state within the length of arrow 320 and up to state B of the graph 300. In some examples, there may not be condensation of the solvents in the recuperator. By installing the recuperator 470 in the apparatus 400, the heat exchanger 130 may have to exchange a lower quantity of energy to condensate the evaporated solvents.

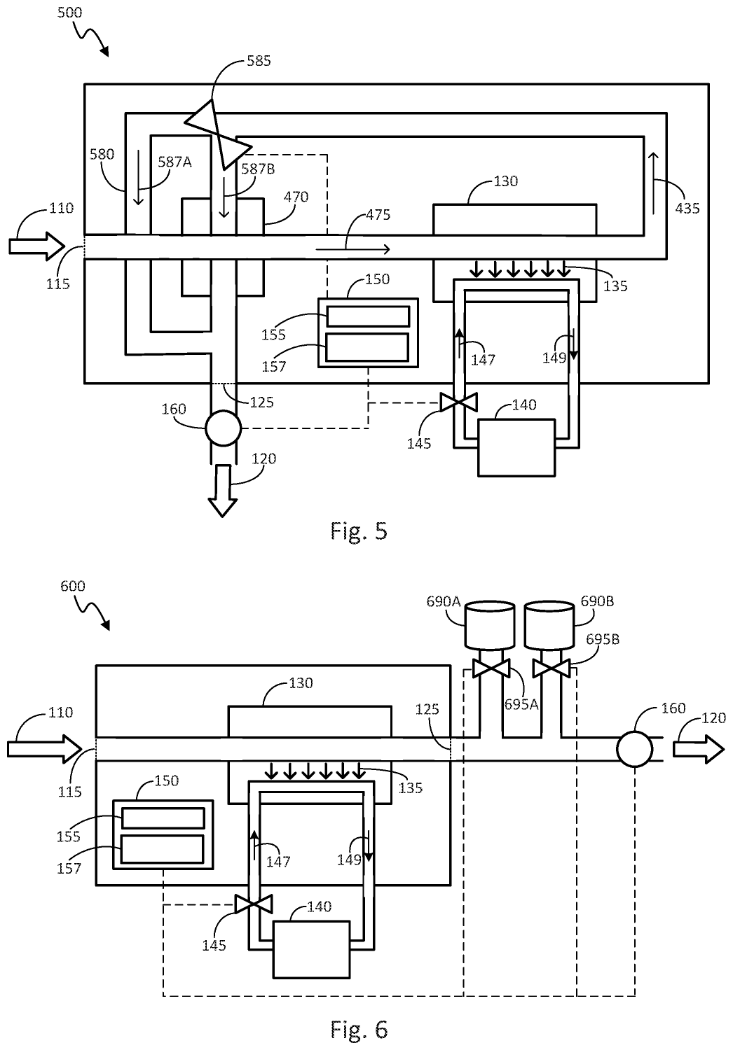

FIG. 5 is another schematic diagram showing another example of a 3D printing apparatus 500 to dehumidify and recycle a gas from a 3D printer (not shown). Additionally, the 3D printing apparatus 500 is to control the humidity and temperature of the recycled gas in the build chamber. The apparatus 500 involves previously disclosed elements from FIG. 4 referred to with the same reference numerals.

In addition to the elements of apparatus 400 from FIG. 4, apparatus 500 comprises a bypass conduit 580 between an exit port? of the recuperator, and a bypass valve 585 within the bypass conduit 580. The controller 150 is coupled with and may control the bypass valve 585. In an example, the controller 150 may control the bypass valve 585 to open and close. In another example, the controller 150 may control the bypass valve 585 to fully open, fully close, partially open, or partially close, where the partial positions may comprise any position ranging from the fully opened and fully closed positions. The bypass conduit is to selectively allow at least part of the dehumidified gas flow 435 to bypass the recuperator 470.

In an example, the bypass valve 585 may be in its closed position, so that all of the dehumidified gas flow 435 passes through the recuperator. In this example, the controller 150 may detect through the sensor 160 that the temperature of the dehumidified gas flow 120 (i.e., gas flow after the recuperator) that is transferred to the 3D printer is above a predeterminable temperature threshold. In this example, the controller 150 may instruct the bypass valve 585 to open or partially open so that a part of the dehumidified gas flow 435 passes through the bypass conduit 580 (arrow 587A) and the remaining part of the dehumidified gas flow 435 passes through the recuperator (arrow 587B). The part of the dehumidified gas flow 435 that passes through the bypass conduit does not heat up, and similarly, is not used to cool the gas flow 110 from the 3D printer. Therefore, the temperature of the resulting gas flow 120 (combination of flow 587A and 587B) after opening or partially opening the bypass valve 585 may be reduced.

FIG. 6 is another schematic diagram showing another example of a 3D printing apparatus 600 to dehumidify and recycle a gas from a 3D printer (not shown). Additionally, the 3D printing apparatus 600 is to control the humidity and temperature of the recycled gas in the build chamber. The apparatus 600 may involve previously disclosed elements from FIG. 1 referred to with the same reference numerals. The apparatus 600 comprises the gas inlet 115, the heat exchanger 130, the gas outlet 125 and the controller 150. The apparatus 600 may additionally comprise or may be engageable with the chiller 140 and the sensor 160. The controller 150 is coupled to the chiller valve 145 from the chiller 140 and the sensor 160. Additionally, apparatus 600 may further comprise elements from apparatus 400 and 500 from FIGS. 4 and 5 respectively.

The controller 150 from apparatus 600 may be coupled with and may control a supply valve 695A. In some examples, the supply valve 695 is external from the apparatus 600. In other examples, the supply valve is an integral element of the apparatus 600. The supply valve 695A is fluidically connectable with a gas source 690A comprising the gas (e.g., gas reservoir). In some examples, the gas source 690A is external but couplable with the apparatus 600. In other examples, the gas source 690A is a removable supply that once installed, it is part of the apparatus 600.

The controller 150 may control a pressure sensor (e.g., sensor 160) to receive from the pressure sensor a measure of a pressure indicative of the pressure within the apparatus 600 conduits. If the controller 150 detects that the pressure within the conduits is below the atmospheric pressure, it may be indicative that a leak may have occurred, and atmospheric air may have entered the system. In order to address this situation and to stop atmospheric gas from entering to the system, the controller 150 may instruct the supply valve 695A to open or partially open to let an amount of gas from the gas source 690A to enter the apparatus 600 and therefore increase the pressure within the apparatus? to a pressure above atmospheric pressure. Once the pressure within the system conduits is above a predeterminable threshold above the atmospheric pressure, the controller 150 may instruct the supply valve 695A to close.

In the examples in which the gas is an inert gas, the atmospheric air that entered the apparatus 600 conduits may have to be removed to avoid potential issues in the build chamber. In order to address this situation, a large amount of inert gas from the gas source 690A may be supplied to the apparatus 600 conduits to purge the small amount of atmospheric air that may have entered to the conduits within the apparatus 600. In an example, the amount of inert gas to be supplied may be multiple times the amount of atmospheric air that may have entered to the conduits.

Additionally, the controller may further control an additional supply valve 695B fluidically connectable with a gas source 690B comprising a gas. In some examples, the gas of the gas source 690B is a different gas than the gas from the gas source 690A. The supply valve 695B and the gas source 690B may be similar to and may be controlled in a similar way than the supply valve 695A and the gas source 690A respectively. Some 3D printers may print different print jobs under different gas environment conditions, for example a first print job with air and a second print job with an inert gas. The apparatus 600 may comprise an independent gas source for each gas to assist in the purge of a first gas corresponding to the previous print job in virtue of the filling of a second gas corresponding to the following job. In some examples, instead of a gas source, the apparatus 600 may capture ambient air from the surrounding environment.

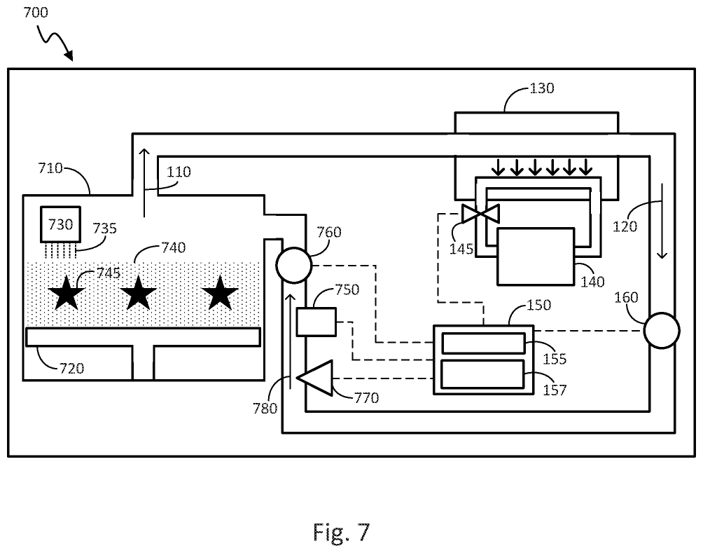

FIG. 7 is a schematic diagram showing an example of a 3D printer 700 that dehumidifies and recycles a gas. Additionally, the 3D printer 700 is to control the humidity and temperature of the recycled gas in the build chamber 710. The apparatus 600 may involve previously disclosed elements from FIG. 1 referred to with the same reference numerals. The 3D printer 700 comprises the heat exchanger 130, the sensor 160 and the controller 150. The 3D printer 700 may additionally comprise or may be engageable with the chiller 140. The controller 150 is coupled to the chiller valve 145. Additionally, 3D printer 700 may further comprise elements from apparatus 400, 500 and 600 from FIGS. 4, 5 and 6 respectively.

The 3D printer 700 comprises a build chamber 710 where 3D objects 745 are generated on a build platform 720 from build material 740. During the generation of the 3D objects 745, the build chamber 710 is subject to a gas flow 780 (e.g., atmospheric air, inert gas) at a specific temperature and humidity. In order to selectively solidify or selectively bind the portions of the build material 740 which are intended to be part of the 3D objects 745, an agent distributor 730 is to selectively deposit a printing fluid 735 with liquid solvents to the build material 740 uppermost layer and an energy source (not shown) is to evaporate part of the liquid solvents into the gas flow (i.e., mix of gas flow and evaporated solvents illustrated as arrow 110).

A first conduit fluidically connects the build chamber 710 to a first end of the heat exchanger 130 and a second conduit fluidically connects a second end of the heat exchanger 130 back to the build chamber 710. The mix of gas and evaporated solvents is transferred from the build chamber 710 to the heat exchanger where the solvents may condense (see, e.g., arrow 320 and 340 of FIG. 3) to thereby dehumidify the gas. The dehumidified gas 120 is transferred to the build chamber 710 though the second conduit.

The 3D printer 700 further comprises a build chamber sensor 760 to measure the temperature and humidity values of the gas flow that is to be recirculated back to the build chamber 710. The build chamber sensor 760 is coupled to and controlled by the controller 150.

The 3D printer 700 further comprises a gas heater 750 and/or a humidifier 770 at the second conduit between the second end of the heat exchanger 130 and the build chamber sensor 760. An example of gas heater 750 may be a resistive heating element. An example of a humidifier 770 may be a vaporizer.

The gas heater 750 and/or the humidifier 770 are coupled to and controlled by the controller 150. The gas heater 750 and/or the gas dehumidifier 770 may be controlled to set the dehumidified gas flow 120 at a build chamber target humidity and a build chamber target temperature based on the measurements of the build chamber sensor 760. The build chamber target humidity and build chamber target temperature may be the same as or similar to the state D examples described above with reference to FIG. 3. The resulting air flow 780 may then enter the build chamber 710.

The above examples may be implemented by hardware, or software in combination with hardware. For example, the various methods, processes and functional modules described herein may be implemented by a physical processor (the term processor is to be implemented broadly to include CPU, SoC, processing module, ASIC, logic module, or programmable gate array, etc.). The processes, methods and functional modules may all be performed by a single processor or split between several processors, reference in this disclosure or the claims to a “processor” should thus be interpreted to mean “at least one processor”. The processes, method and functional modules are implemented as machine-readable instructions executable by at least one processor, hardware logic circuitry of the at least one processor, or a combination thereof.

The drawings in the examples of the present disclosure are some examples. It should be noted that some units and functions of the procedure may be combined into one unit or further divided into multiple sub-units. What has been described and illustrated herein is an example of the disclosure along with some of its variations. The terms, descriptions and figures used herein are set forth by way of illustration. Many variations are possible within the scope of the disclosure, which is intended to be defined by the following claims and their equivalents.

There have been described example implementations with the following sets of features:

Feature set 1: A 3D printing apparatus to dehumidify and recycle a gas from a 3D printer, the apparatus comprising:
a gas inlet to receive a gas flow from a 3D printer, the gas flow comprising gas with evaporated solvents to be cleaned;
a heat exchanger to dehumidify the gas flow from the evaporated solvents, the heat exchanger to cool the gas flow by heat transfer to a cold liquid stream from a chiller to saturate and condensate the solvents from the gas flow;
a gas outlet to output the dehumidified gas flow back to the 3D printer; and
a controller to:
   receive a humidity and temperature measurements from a sensor located downstream from the heat exchanger;
   compare the humidity and temperature measurements with a target humidity and a target temperature respectively; and
   control a chiller valve from the chiller based on the comparison to adjust the temperature of the gas flow to set an absolute humidity of the gas flow to a predeterminable value.

Feature set 2: A 3D printing apparatus with feature set 1, wherein the gas comprises an inert gas.

Feature set 3: A 3D printing apparatus with any preceding feature set 1 to 2, wherein the gas comprises Nitrogen.

Feature set 4: A 3D printing apparatus with any preceding feature set 1 to 3, further comprising a recuperator to cool the gas flow from the 3D printer and to heat the dehumidified gas flow through gas heat exchange means.

Feature set 5: A 3D printing apparatus with any preceding feature set 1 to 4, further comprising a bypass conduit between the ends of the recuperator to selectively allow the dehumidified gas flow to bypass the recuperator; a bypass valve within the conduit; and the controller to control the bypass valve position based on the comparison between the measured temperature and the target temperature so that the temperature of the dehumidified gas flow is below a temperature threshold.

Feature set 6: A 3D printing apparatus with any preceding feature set 1 to 5, further comprising a supply valve to fluidically connect the 3D printing apparatus with a gas source comprising the gas; and the controller to control the supply valve to input an amount of gas to the gas flow so that that the gas flow pressure within the 3D printing apparatus is above an atmospheric pressure.

Feature set 7: A 3D printing apparatus with any preceding feature set 1 to 6, w wherein the gas source is an air source, the apparatus further comprising: an additional supply valve to fluidically connect the 3D printing apparatus with an inert gas source comprising the inert gas; and the controller to control the additional supply valve to input an amount of the inert gas to the gas flow so that the gas flow pressure within the 3D printing apparatus is above the atmospheric pressure.

Feature set 8: A 3D printing apparatus with any preceding feature set 1 to 7, wherein the controller is further to control a gas heater and/or a humidifier from the 3D printer to set the dehumidified gas at a build chamber target humidity and a build chamber target temperature.

Feature set 9: A 3D printer comprising:
a build chamber subject to a gas flow to receive a build material layer to be used in the generation of a 3D object;
an agent distributor to selectively deposit a printing fluid with liquid solvents to the build material layer;
an energy source to evaporate the liquid solvents to the gas flow;
a first conduit to fluidically connect the build chamber to a first end of a heat exchanger;
the heat exchanger to dehumidify the gas flow with solvents from the build chamber, the heat exchanger to cool the gas flow with solvents by heat transfer to a cold liquid stream from a chiller to saturate and condensate the solvents from the gas flow;
a second conduit to fluidically connect a second end of a heat exchanger back to the build chamber;
a sensor to measure a humidity and temperature from the dehumidified gas flow within the second conduit; and
a controller to:
   receive a humidity and temperature measurements from the sensor;
   compare the humidity and temperature measurements with a target humidity and a target temperature respectively; and
   control a chiller valve from the chiller based on the comparison to adjust the temperature of the gas flow to set an absolute humidity of the gas flow to a predeterminable value.

Feature set 10: A 3D printer with feature set 9, wherein the gas is an inert gas.

Feature set 11: A 3D printer with any preceding feature set 9 to 10, further comprising a recuperator to cool the gas flow from the 3D printer and to heat the dehumidified gas flow

Feature set 12: A 3D printer with any preceding feature set 9 to 11, further comprising: a bypass conduit between the ends of the recuperator to selectively allow the dehumidified gas flow to bypass the recuperator; a bypass valve within the conduit; and the controller to control the bypass valve position based on the comparison between the measured temperature and the target temperature so that the temperature of the dehumidified gas flow is below a temperature threshold.

Feature set 13: A 3D printer with any preceding feature set 9 to 12, further comprising a humidifier to set the dehumidified gas at a build chamber target humidity and a build chamber target temperature.

Feature set 14: A 3D printer with any preceding feature set 9 to 13, further comprising a gas heater to set the dehumidified gas at a build chamber target humidity and a build chamber target temperature.

Feature set 15: A method to dehumidify and recycle a gas within a 3D printer, the method comprising:
inputting a gas flow with solvents from a 3D printer to a heat exchanger;
inputting a cold liquid stream from a chiller to the heat exchanger;
cooling the gas flow with solvents by heat transfer to the cold liquid stream to saturate and condensate the solvents and thereby dehumidifies the gas flow from the solvents;
measuring a humidity and temperature of the dehumidified gas flow;
comparing the humidity and temperature measurements with a target humidity and a target temperature respectively; and
operating a chiller valve from the chiller based on the comparison to adjust the temperature of the gas flow to set an absolute humidity of the gas flow to a predeterminable value.

What it is claimed is:

1. A 3D printing apparatus to dehumidify and recycle a gas from a 3D printer, the apparatus comprising:
a gas inlet to receive a gas flow from a 3D printer, the gas flow comprising gas with evaporated solvents to be cleaned;
a heat exchanger to dehumidify the gas flow from the evaporated solvents, the heat exchanger to cool the gas flow by heat transfer to a cold liquid stream from a chiller to saturate and condensate the solvents from the gas flow;
a gas outlet to output the dehumidified gas flow back to the 3D printer; and
a controller to:
receive a humidity and temperature measurements from a sensor located downstream from the heat exchanger;
compare the humidity and temperature measurements with a target humidity and a target temperature respectively; and
control a chiller valve from the chiller based on the comparison to adjust the temperature of the gas flow to set an absolute humidity of the gas flow to a predeterminable value.

2. The 3D printing apparatus of claim 1, wherein the gas comprises an inert gas.

3. The 3D printing apparatus of claim 2, wherein the gas comprises Nitrogen.

4. The 3D printing apparatus of claim 1, further comprising a recuperator to cool the gas flow from the 3D printer and to heat the dehumidified gas flow through gas heat exchange means.

5. The 3D printing apparatus of claim 4, further comprising:
a bypass conduit between the ends of the recuperator to selectively allow the dehumidified gas flow to bypass the recuperator;
a bypass valve within the conduit; and
the controller to control the bypass valve position based on the comparison between the measured temperature and the target temperature so that the temperature of the dehumidified gas flow is below a temperature threshold.

6. The 3D printing apparatus of claim 1, further comprising:
a supply valve to fluidically connect the 3D printing apparatus with a gas source comprising the gas; and
the controller to control the supply valve to input an amount of gas to the gas flow so that that the gas flow pressure within the 3D printing apparatus is above an atmospheric pressure.

7. The 3D printing apparatus of claim 6, wherein the gas source is an air source, the apparatus further comprising:
an additional supply valve to fluidically connect the 3D printing apparatus with an inert gas source comprising the inert gas; and
the controller to control the additional supply valve to input an amount of the inert gas to the gas flow so that the gas flow pressure within the 3D printing apparatus is above the atmospheric pressure.

8. The 3D printing apparatus of claim 1, wherein the controller is further to control a gas heater and/or a humidifier from the 3D printer to set the dehumidified gas at a build chamber target humidity and a build chamber target temperature.

9. A 3D printer comprising:
a build chamber subject to a gas flow to receive a build material layer to be used in the generation of a 3D object;
an agent distributor to selectively deposit a printing fluid with liquid solvents to the build material layer;
an energy source to evaporate the liquid solvents to the gas flow;
a first conduit to fluidically connect the build chamber to a first end of a heat exchanger;
the heat exchanger to dehumidify the gas flow with solvents from the build chamber, the heat exchanger to cool the gas flow with solvents by heat transfer to a cold liquid stream from a chiller to saturate and condensate the solvents from the gas flow;
a second conduit to fluidically connect a second end of a heat exchanger back to the build chamber;
a sensor to measure a humidity and temperature from the dehumidified gas flow within the second conduit; and
a controller to:
receive a humidity and temperature measurements from the sensor;
compare the humidity and temperature measurements with a target humidity and a target temperature respectively; and
control a chiller valve from the chiller based on the comparison to adjust the temperature of the gas flow to set an absolute humidity of the gas flow to a predeterminable value.

10. The 3D printer of claim 9, wherein the gas is an inert gas.

11. The 3D printer of claim 9, further comprising a recuperator to cool the gas flow from the 3D printer and to heat the dehumidified gas flow through gas heat exchange means.

12. The 3D printer of claim 11, further comprising
a bypass conduit between the ends of the recuperator to selectively allow the dehumidified gas flow to bypass the recuperator;
a bypass valve within the conduit; and
the controller to control the bypass valve position based on the comparison between the measured temperature and the target temperature so that the temperature of the dehumidified gas flow is below a temperature threshold.

13. The 3D printer of claim 9, further comprising a humidifier to set the dehumidified gas at a build chamber target humidity and a build chamber target temperature.

14. The 3D printer of claim 9, further comprising a gas heater to set the dehumidified gas at a build chamber target humidity and a build chamber target temperature.

15. A method to dehumidify and recycle a gas within a 3D printer, the method comprising:
inputting a gas flow with solvents from a 3D printer to a heat exchanger;
inputting a cold liquid stream from a chiller to the heat exchanger;
cooling the gas flow with solvents by heat transfer to the cold liquid stream to saturate and condensate the solvents and thereby dehumidifies the gas flow from the solvents;
measuring a humidity and temperature of the dehumidified gas flow;
comparing the humidity and temperature measurements with a target humidity and a target temperature respectively; and
operating a chiller valve from the chiller based on the comparison to adjust the temperature of the gas flow to set an absolute humidity of the gas flow to a predeterminable value.
